(19) United States
(12) Patent Application Publication
(10) Pub. No.: US 2010/0279605 A1
(43) Pub. Date: Nov. 4, 2010

(54) METHOD AND DEVICE FOR DATA AND/OR ENERGY TRANSMISSION

(76) Inventors: Heinrich Haas, Meckenbeuren (DE); Wolfgang Schulter, Meersburg (DE); Ulrich Möller, Holzkirchen (DE)

Correspondence Address: RATNERPRESTIA, P.O. BOX 980, VALLEY FORGE, PA, 19482, US

(21) Appl. No.: 12/670,736

(22) PCT Filed: Jun. 24, 2008
(86) PCT No.: PCT/DE08/01011

§ 371 Date: Jun. 23, 2010

(30) Foreign Application Priority Data
Jul. 27, 2007 (DE) 10 2007 035 310.5

(51) Int. Cl. H02J 17/00; G01B 7/14; H04B 5/00

(52) U.S. Cl. 455/41.1; 307/104; 324/207.11

(57) ABSTRACT

A device and a method for data and/or energy transmission from a stationary part to a pane-shaped part which is movable relative to the stationary part, particularly a window pane of a motor vehicle, and/or vice versa. Data and/or energy is transmitted between an electrical unit in or on the stationary part and an electrical unit in or on a pane-shaped part which is movable relative to the stationary part, particularly an adjustable window pane, by electromagnetic interaction between at least one induction coil in the form of a conductor loop which is arranged in or on the pane-shaped movable part and at least one annular magnetic circuit which is arranged in or on the stationary part. Use of the device as an anti-trap protection for the pane-shaped movable part, particularly for the adjustable window pane of a vehicle, and/or as a theft protection for a vehicle is described.

### CROSS REFERENCE TO RELATED APPLICATIONS

This application is the U.S. national phase application of PCT International Application No. PCT/DE2008/001011, filed Jun. 24, 2008, which claims priority to German Patent Application No. 10 2007 035 310.5, filed Jul. 27, 2007, the contents of such applications being incorporated by reference herein.

### BACKGROUND OF THE INVENTION

The present invention relates to a device and a method for data and/or energy transmission from a preferably stationary part to a pane-shaped part which is movable relative to said stationary part, particularly a window pane of a motor vehicle, and/or vice versa. Furthermore, the invention relates to the use of the device according to aspects of the invention as an anti-trap protection for said pane-shaped movable part, particularly for the adjustable window pane of a vehicle, and/or as a theft protection for a vehicle. The device according to aspects of the invention can also be used as a transmitting and/or receiving antenna.

To make a vehicle safer and more comfortable, the window panes of said vehicle, particularly the adjustable window panes, are equipped with several functions nowadays.

For example, the publication DE 10 2005 003 181 A1 which is incorporated by reference describes a multifunctional window pane and a method for operating a multifunctional window pane of a vehicle. According to the publication, said multifunctional window pane comprises an electrical display layer for displaying vehicle operating data.

The publication DE 10 2004 050 987 A1 which is incorporated by reference describes a window pane of a vehicle having functional elements which can reversibly change colour electrochromically to protect the driver from being blinded by rays of light coming from outside.

To implement the aforesaid functions, electronic components are required, such as said electrical display layer, said electrochromic functional elements arranged in or on the window pane and which are supplied with electrical energy and/or must exchange data with the equipment in or on the stationary vehicle part, for example in or on the vehicle door.

Furthermore, a device is required with the aid of which energy and/or data can be transmitted from the stationary vehicle part or from the vehicle door to a(n) (adjustable) window pane which is installed in said vehicle door and vice versa.

The publication DE 100 03 842 A1 which is incorporated by reference describes a device for the wireless transmission of signals and energy from movable units to stationary or movable units, wherein said transmission is accomplished by means of a transmission link which is constituted by two coupled resonant circuits which are tuned to one another and can be moved relative to each other.

The drawback of such a device is that such a transmission link has a very low degree of interaction and the signals which are transmitted via said transmission link are exposed to the surroundings, particularly to electromagnetic radio waves, and therefore very susceptible to interference. Such a device is therefore not suitable for data transmission to the window pane of a vehicle in particular since there are relatively strong electromagnetic radio waves in or on the vehicle, for example from the antennae of the keyless entry system.

The patent document EP 0092 773 which is incorporated by reference discloses a device for the inductive transmission and evaluation of signals, particularly of switching commands, from a unit which can be moved along a predetermined path and is provided with a switch that can be actuated by external action to an evaluation unit, wherein along the predetermined path or parallel thereto a conductor loop is provided to which an alternating voltage signal is fed and wherein an inductor arranged on the movable unit and which is coupled to said conductor loop can be changed by means of said switch.

Such a device is, however, not suitable for data and/or energy transmission from a preferably stationary part to a pane-shaped part which is movable relative to said stationary part, for example an adjustable window pane, since it is rather complicated to arrange such a device on a window pane in terms of production engineering. In addition, such a device is also susceptible to electromagnetic interference.

### SUMMARY OF THE INVENTION

It is therefore an object of the present invention to provide a device and a method of the kind mentioned in the opening paragraph which enables data and/or energy to be transmitted efficiently and with little interference from a preferably stationary part, for example a vehicle door, to a pane-shaped part which is movable relative to said stationary part, for example a window pane, and vice versa.

Furthermore, the device according to aspects of the invention is intended to permanently detect the position and the running speed and/or acceleration of the movable pane-shaped part, for example the window pane, and the detected motion data are to be used to enable an effective, reliable anti-trap protection for said pane-shaped part. In addition, the device according to aspects of the invention is also intended to implement theft protection.

A central idea of the invention is to arrange a number of electrically conductive structures in the form of a conductor loop in or on the movable pane-shaped part, for example a window pane, and to arrange a magnetic circuit in or on the stationary part, such as e.g. in the vehicle door, wherein said magnetic circuit is radially interrupted by a gap, thus being C-shaped. At least one electrically conductive coil, specifically a choking coil, is wound around the magnetic circuit. The magnetic circuit preferably consists of a ferro-magnetic material. Such a magnetic circuit is referred to as an unbranched magnetic circuit with air gap in specialist literature. The area of the pane-shaped part, for example the window pane, which is enclosed by the induction coil is located in the area of the gap of the magnetic circuit. The width of the gap of the magnetic circuit is such that the area of the pane-shaped part which is enclosed by the induction coil is just able to move in said gap.

If the pane-shaped part, for example the window pane, does not move, the device is preferably used to transmit energy and/or data. This means that data and/or energy can be transmitted with less power loss and little interference from the vehicle door to the window pane and vice versa, regardless of the relative position between the movable pane-shaped part, for example the window pane, and the stationary part, for example the vehicle door.

If the pane-shaped part, for example the adjustable window pane, is moved, the device according to aspects of the invention can be used as an anti-trap protection. Said device has a very high electromagnetic interaction between the magnetic circuit and the induction coil on the window pane due to the very narrow gap on the magnetic circuit, the characteristic of the magnetic circuit to be ferromagnetic and the dimensions and arrangement of the induction coil on the window pane. For this reason, the position of the window pane, the running speed and the acceleration of the relative movement of the window pane in relation to the vehicle door can be detected with relatively high precision.

Furthermore, both the induction coil in or on the window pane and the magnetic circuit around which an induction coil is wound can be used as a transmitting/receiving antenna, for example for the keyless entry system. It is also possible, however, to arrange a further induction coil in or on the window pane to ensure radio-based data communication with little interference.

In addition, the device according to aspects of the invention can also be used as a theft protection. For example, if the window pane is broken or the window frame including the window pane is forcefully bent sideways, the magnetic field of the induction coil arranged on the window pane and to which a current is supplied will change. Said change of the magnetic field induces an induction current in the choking coil. Said induction current is preferably detected by an alarm system in the vehicle, thus triggering an alarm signal.

In the first place, the device according to aspects of the invention and/or the method according to aspects of the invention enable(s) wireless data and/or energy transmission between electrical components which are a distributed in at least two parts that are movable relative to each other and one of which has a thin, sheet-like pane shape, for example a window pane. The aim is to avoid complicated solutions involving direct cabling.

Since the energy and/or data transmission is based on the electromagnetic interaction of two induction coils, energy as well as data can be transmitted from the vehicle door to the window pane or vice versa with no need to restructure the device. The electromagnetic interaction of the two induction coils is enhanced by means of the magnetic circuit located between the two induction coils. The magnetic circuit including an air gap which radially interrupts said magnetic circuit enables the interaction between the two induction coils to be enhanced on the one hand due to the fact that the magnetic circuit concentrates the magnetic field in the area of the air gap and perpendicular movement of the pane-shaped part through said air gap on the other.

The device according to aspects of the invention will now be explained in more detail with reference to an exemplary embodiment and with the aid of Figures. The illustrated exemplary embodiment is a device according to aspects of the invention for a vehicle door including an adjustable window pane. In the Figures, only those components are shown which are important for the description of the device according to aspects of the invention. To make the system more reliable, the design of the device according to aspects of the invention may deviate from the Figures shown and be much more complex. For improved visibility, the components are shown at different scales in the Figures. For example, the magnetic circuit is shown enlarged, compared to the window pane.

### BRIEF DESCRIPTION OF THE DRAWINGS

In the Figures:

FIG. 1 shows a schematic view of the device according to aspects of the invention for a vehicle door including an adjustable window pane;

FIG. 2 shows a cross section of the window pane along line AA, including an inventive device according to FIG. 1;

FIG. 3 shows a detailed view of the inventive device according to FIG. 1.

### DETAILED DESCRIPTION OF THE PREFERRED EMBODIMENTS

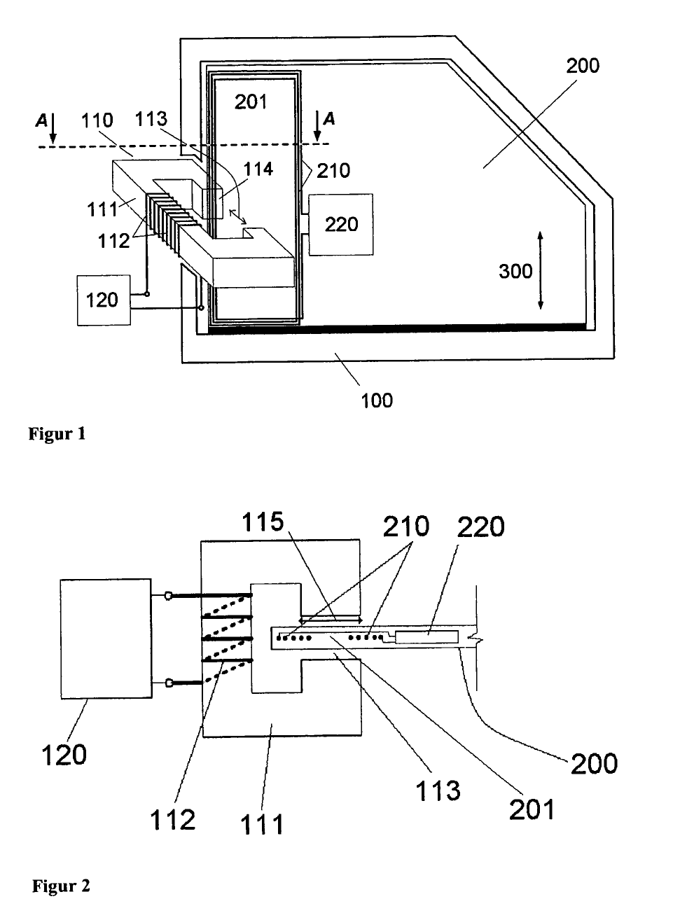

FIG. 1 shows a schematic view of a device according to aspects of the invention. By way of example, a device for a vehicle door 100 including an adjustable 300 window pane 200 is illustrated here. Such a device essentially consists of two units 110 and 210. The unit 110 in the vehicle door 100, preferably in the window frame, comprises at least one magnetic circuit 111, at least one choking coil 112 which is wound around said magnetic circuit 111. The magnetic circuit 111 is provided with an air gap 113 which radially interrupts said magnetic circuit 111. The unit 210 on the window pane 200 comprises at least one induction coil 210 having a number of turns, preferably in the form of a conductor loop, which encloses an area 201 of said window pane 200. The air gap 113 of the magnetic circuit 111 is located in the area 201 of the window pane 200 which is enclosed by the induction coil 210 and overlaps with said area 201. If the window pane 200 is adjusted 300, the window pane 200, particularly the area 201 of said window pane 200, around which the induction coil 210 is wound, will move perpendicular to the air gap 113 of the magnetic circuit 111. The width of the air gap 113 is such that the area 201 of the window pane 200 which is enclosed by the induction coil 210 is just able to move in said air gap 113.

The magnetic circuit 111 and the small distance between the two ends of said magnetic circuit 111 and the induction coil 210 or the area 201 of the window pane 200 which is enclosed by said induction coil 210 have the decisive advantage that the efficiency of the data and/or energy transmission between the two induction coils 112, 210 is very high and said data and/or energy transmission is less susceptible to electromagnetic interference.

An electrical or electronic unit 220 is arranged on the window pane 200. This unit 220 essentially comprises those components which require electrical energy from a stationary electrical unit 120, receive data, such as functional commands, from said stationary unit 120 and/or transmit sensor data to said stationary unit 120. These can be an energy store, a data store, a data evaluation device, data output electronics and/or data reading electronics. In case of a window pane which can darken automatically, said components can also be those sheet-like elements which can change colour electrochromically. Furthermore, it can be conceived to use suitable structures, e.g. a further induction coil on the window pane 200, to implement transmitting/receiving antennae as they are required in touchless entry or operating systems, such as “Passive Entry”, and with no need of a complicated galvanic connection to the stationary unit 120.

Furthermore, photovoltaic elements for converting sunlight into electrical energy can also be arranged on the window pane 200. This energy can then be transferred to the automotive battery in the vehicle or to the electrical components of the stationary unit 120 via the device 110, 210 according to aspects of the invention.

The stationary unit 120 comprises all components which are arranged in the vehicle door 100 or in the vehicle in a stationary manner and supply energy to the unit 220 on the window pane 200 or draw electrical energy from said unit 220 and/or exchange data with said unit 220.

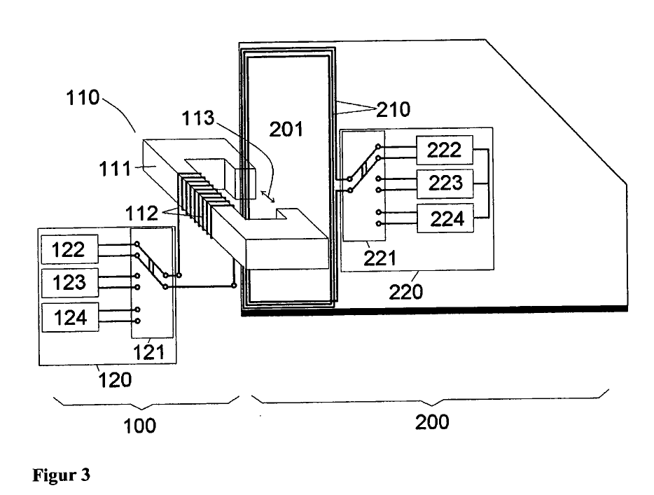

FIG. 2 shows a top view of the magnetic circuit of the inventive device of FIG. 1, with the transverse section of the window pane along line AA in the direction of the arrow.

The air gap 113 of the magnetic circuit 111 is located in the area 201 of the window pane 200 which is enclosed by the induction coil 210 and overlaps with said area 201. The width of the air gap 113 is such that the window pane 200 is just able to move in said gap 113 and perpendicular to said gap 113 if it is adjusted 300.

FIG. 3 shows the inventive device of FIG. 1 in more detail. According to this Figure, the electronic unit 220 in the window pane 200 comprises three functional units 222, 223, 224 which are connected to the induction coil 210 located on the window side in the window pane 200 by means of a control unit 221 so as to be electrically switchable. The electronic unit 120 located on the vehicle side comprises three functional units 122, 123, 124 preferably corresponding to the functional units 222, 223, 224 in the window pane 200 and which are distributed in the vehicle door 100 and/or in the vehicle, which is not indicated in this Figure, and are also connected to the induction coil 112 which is wound around the magnetic circuit 111 by means of a control unit 121 so as to be electrically switchable.

The first functional unit 222 on the window pane 200 can be an energy consumer which is integrated in said window pane 200. Accordingly, the corresponding functional unit 122 in the vehicle can, for example, be a generator or a battery in said vehicle.

To transmit energy from the battery located on the vehicle side to the energy consumer in the window pane 200, said energy consumer which is integrated in said window pane 200, for example 122, is electrically connected to the induction coil 210 which is integrated on the window side, specifically in said window pane 200, by means of the control unit 221 located on the window side. Accordingly, the battery, for example 122, in the vehicle is electrically connected to the choking coil 112 which is wound around the magnetic circuit 111 on the side of the vehicle door by means of the control unit 121 located on the side of the vehicle door.

Electrical energy from the battery located on the vehicle side, for example 122, is converted to magnetic energy by the choking coil 112 which is wound around the magnetic circuit 111. Said magnetic energy is bundled by the magnetic circuit 111 and concentrated in the area of the gap 113. Said energy in the form of a magnetic field induces the induction current in the induction coil 210 located on the window side. Said induction current is then stored in the energy storage cells, for example 222, in the window pane 200.

It is preferred that data and/or energy are transmitted if the window pane 200 does not move relative to the vehicle door 100, regardless of whether the window pane 200 is completely moved out of or completely retracted in the vehicle door 100. Provided appropriate measures are taken, data and/or energy can also be transmitted during adjustment 3000 of the window pane 200.

The functional unit 222 in the window pane 200 can, however, also be a group of solar cells and energy storage cells which convert solar energy to electrical energy and store said electrical energy in said energy storage cells in said window pane 200. In this case, energy is preferably transmitted from the energy stores in the window pane 200 to the battery in the vehicle by means of the device 110, 210 according to aspects of the invention.

The device 110, 210 according to aspects of the invention can be used as an anti-trap protection. If the window pane 200 is adjusted, for example if the window is closed, the induced electromagnetic field of the induction coil 210 to which a current is supplied will move relative to the magnetic circuit 111 or the air gap 113 of said magnetic circuit 111. The “moving” electromagnetic field produces an induction current in the magnetic circuit 111 which is then permanently detected by a measuring unit. The change in running speed or acceleration or deceleration of the window pane 200 can be determined by comparing the currently detected values of the induction voltage and induction current to reference values which have been stored earlier. Said change in running speed or acceleration or deceleration in turn provides information regarding potential trapping on said window pane 200. Alternatively, the choking coil 112 which is wound around the magnetic circuit 111 can be supplied with a preferably constant current. Said current produces an electromagnetic field in the area of the gap 113 which in turn produces induction currents in the induction coil 210. If the window pane 200 including the induction coil 210 moves relative to the magnetic circuit 111, the induction voltage and induction current in said induction coil 210 will change. Said change is detected by a measuring unit and transferred for detection of the change in running speed or acceleration or deceleration of the window pane 200.

The width of the air gap 113 of the magnetic circuit 111 and the arrangement of the induction coil 210 in the window pane are such that the window pane 200 including said induction coil 210 is just able to move through said gap 113 and that the area 201 which is enclosed by said induction coil 210 just encloses the cross section 114 of said air gap 113 in the side length 115 thereof.

If the device 110, 210 according to aspects of the invention including the functional units, e.g. 124 and 224, is operated as a theft protection, the choking coil 112 which is wound around the magnetic circuit 111 is supplied with a preferably constant current by the functional unit 124. The functional unit 224 in the window pane 200 preferably comprises an alarm system. The induction coil 210 located on the window side detects the magnetic field which is induced by the choking coil 112 located on the vehicle side. If the window pane 200 is broken or the window frame including said window pane 200 is forcefully bent sideways by a vehicle thief, the magnetic field in the induction coil 210 located on the window side will change. Said change of the magnetic field is detected by the functional unit 224 and triggers an alarm therein. Alternatively, the induction coil 210 located on the window side can be supplied with a preferably constant current. The electromagnetic field produced by the induction coil 210 to which a current is supplied induces induction currents in the choking coil 112 via the magnetic circuit 111. If the window pane 200 is broken or the window frame including said window pane 200 is forcefully bent sideways by a vehicle thief, the current flow in the induction coil 210 can be disrupted or interrupted. Said disruption will result in a change of the electromagnetic field. Said change in turn affects the induction current in the choking coil and results in a change of the induction current. Said change of the induction current is measured and triggers an alarm.

according to aspects of the invention according to aspects of the invention

1.-9. (canceled)

10. A device for data and/or energy transmission between an electrical unit in or on a stationary part and an electrical unit in or on a pane-shaped part which is movable relative to said stationary part, wherein said device comprises:
at least one induction coil in the form of a conductor loop which is arranged in or on said pane-shaped movable part and at least one magnetic circuit which is arranged in or on said stationary part,
wherein said magnetic circuit comprises an air gap,
wherein said air gap is located in an area of the pane-shaped part which is enclosed by the induction coil and overlaps with said area, and
wherein data and/or energy is transmitted by electromagnetic interaction between said induction coil and said magnetic circuit.

11. A device according to claim 10, wherein the air gap radially interrupts the magnetic circuit.

12. A device according to claim 10, wherein at least one choking coil is wound around the magnetic circuit.

13. A device according to claim 10, wherein a width of the air gap of the magnetic circuit is such that an area of the pane-shaped part which is enclosed by the induction coil is able to move in said air gap and perpendicular to said air gap.

14. A device according to claim 10, wherein the device detects a position, a running speed and an acceleration of a relative movement of the pane-shaped part relative to the stationary part.

15. A device according to claim 10, wherein the pane-shaped part is an adjustable window pane.

16. Use of the device according to claim 10 as an anti-trap protection.

17. Use of the device according to claim 10 as a transmitting antenna, a receiving antenna or both a transmitting antenna and a receiving antenna.

18. Use of the device according to claim 10 as a theft protection.

19. A method for data and/or energy transmission between an electrical unit in or on a stationary part and an electrical unit in or on a pane-shaped part which is movable relative to the stationary part, said method comprising the steps of:
transmitting data and/or energy by electromagnetic interaction between at least one induction coil in the form of a conductor loop which is arranged in or on the pane-shaped movable part and at least one magnetic circuit which is arranged in or on the stationary part; and
interrupting the magnetic circuit by an air gap,
wherein at least one choking coil is wound around the magnetic circuit,
wherein the air gap is located in an area of the pane-shaped part which is enclosed by the induction coil and overlaps with the area, and
wherein a width of the air gap of the magnetic circuit is such that the area of said pane-shaped part which is enclosed by the induction coil is able to move in the air gap and perpendicular to the air gap.
